(19) United States
(12) Patent Application Publication
(10) Pub. No.: US 2008/0133373 A1
(43) Pub. Date: Jun. 5, 2008

(54) METHOD TO SELECT PAYMENT WHEN USING A WIRELESS COMMUNICATION DEVICE

(75) Inventors: Jorge L. Perdomo, Boca Raton, FL (US); Daniel A. Baudino, Lake Worth, FL (US); Nona E. Gage, Sea Ranch Lakes, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/686,151

(22) Filed: Mar. 14, 2007

Related U.S. Application Data
(60) Provisional application No. 60/868,028, filed on Nov. 30, 2006.

(51) Int. Cl. G06Q 20/00

(52) U.S. Cl. 705/18; 235/380

(57) ABSTRACT

A method (400) of selecting a financial account to be used to make a payment and a mobile station (105) that may implement the method. The method can include identifying at least one of a plurality of user profiles during a payment transaction at a point-of-sale terminal (110). The method also can include selecting from a plurality of available financial accounts at least one financial account that is associated with the identified user profile and making the payment using the selected financial account.

### CROSS REFERENCES TO RELATED APPLICATIONS

This application claims benefit of U.S. provisional patent application Ser. No. 60/868,028, filed Nov. 30, 2006, which is herein incorporated by reference.

### BACKGROUND OF THE INVENTION

1. Field of the Invention

The present invention generally relates to mobile stations and, more particularly, to mobile stations that may be used to make payments at point-of-sale terminals.

2. Background of the Invention

Mobile stations currently are being developed which may be used to make contactless payments at point-of-sale terminals. For example, when a consumer is at a check-out counter of a retail store, in lieu of swiping a credit card or paying with cash or check, the user will be able to pay for his merchandise using his mobile station. For instance, using near filed communication signals, the mobile station will be able to wirelessly communicate account information for one of the user's credit cards or debit cards to the point-of-sale terminal.

When the user stores information for multiple credit and debit cards on his mobile station, the user can select which credit/debit account is to be used for payment in the transaction. For example, the user can navigate through a series of menus provided on the display of the mobile station in order to make a credit/debit account selection. Navigating through such menus can be cumbersome, however.

### SUMMARY OF THE INVENTION

The present invention relates to a method of selecting a financial account to be used to make a payment at a point-of-sale terminal. The method can include identifying at least one of a plurality of user profiles during a payment transaction at a point-of-sale terminal. The method also can include selecting from a plurality of available financial accounts at least one financial account that is associated with the identified user profile, and making the payment using the selected financial account. The method further can include associating each of the plurality of financial accounts with at least one user profile selected from the plurality of user profiles. In response to making the payment, an electronic message can be sent to a contact associated with the selected financial account.

In one arrangement, selecting at least one financial account can include selecting a first financial account associated with the identified user profile and, in response to determining that the first financial account is not available to make payment for the payment transaction, selecting a second account associated with the identified user profile. Selecting the first financial account also can include selecting the financial account that has a highest priority from among the financial accounts associated with the user profile.

The method also can include receiving a first identifier associated with a mobile station accessory. In such an arrangement, identifying the at least one user profile can include determining that the user profile is associated with the first identifier. Further, a second identifier associated with a location can be received. In this arrangement, identifying the at least one user profile can include determining that the user profile is associated with the first identifier and the second identifier. In another aspect of the invention the method can include receiving a first identifier associated with a wearable item. In this arrangement, identifying the at least one user profile can include determining that the user profile is associated with the first identifier. In another arrangement, identifying the at least one user profile can include receiving a user selection of the user profile.

The method further can include receiving financial information for each of the financial accounts. In this arrangement, selecting the financial account can include processing the financial information. The method also can include receiving at least one biometric parameter. Identifying the at least one user profile can include determining that the user profile is associated with the received biometric parameter.

The present invention also relates to a mobile station suitably configured to make a payment at a point-of-sale terminal. The mobile station can include at least a first transceiver and a controller. During a payment transaction at a point-of-sale terminal, the controller can identify at least one of a plurality of user profiles, select from a plurality of available financial accounts at least one financial account that is associated with the identified user profile, and communicate to the transceiver information to be communicated to the point-of-sale terminal in order to make the payment using the selected financial account. The controller can associate each of the plurality of financial accounts with at least one user profile selected from the plurality of user profiles.

Further, the first transceiver or a second transceiver of the mobile station can receive a first identifier associated with a mobile station accessory. The controller can determine that the user profile is associated with the first identifier. The first transceiver or the second transceiver also can receive a second identifier associated with a location. In this arrangement the controller can determine that the user profile is associated with the first identifier and the second identifier. In another aspect of the invention, the first transceiver or the second transceiver can receive a first identifier associated with a wearable item and the controller can determine that the user profile is associated with the first identifier.

The first transceiver or the second transceiver can receive financial information for each of the financial accounts and the controller can process the financial information in order to select the financial account that is associated with the identified user profile.

The mobile station also can include a biometric sensor that receives at least one biometric parameter. The controller can determine that the user profile is associated with the received biometric parameter.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of a mobile station that is useful for understanding the present invention;

FIG. 3 is a flowchart that is useful for understanding the present invention; and

FIG. 4 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

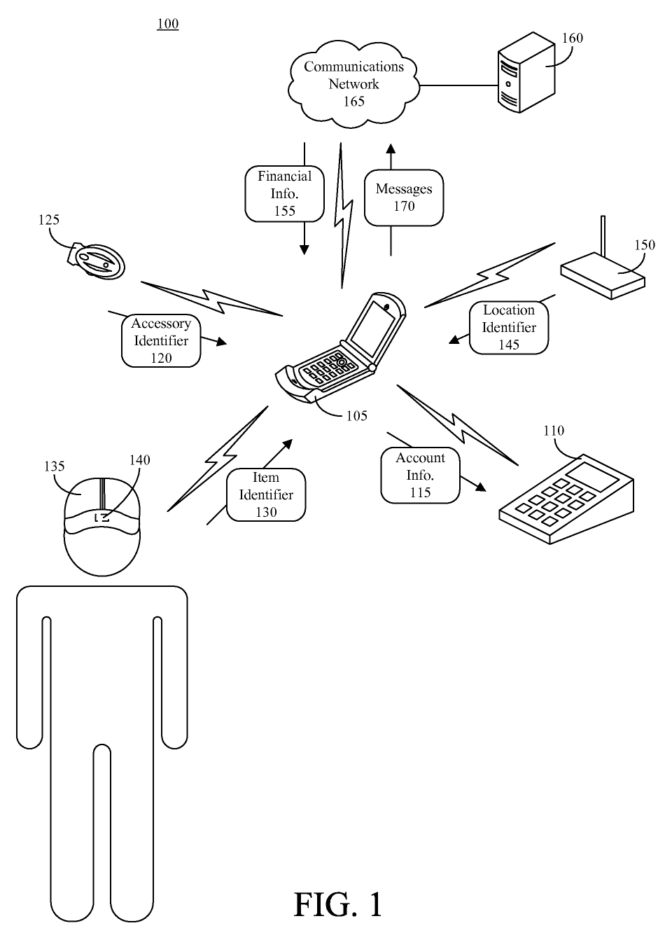

FIG. 1 depicts a communications system 100 that is useful for understanding the present invention. The communications system 100 can include a mobile station 105. The mobile station 105 can be a mobile telephone, a mobile radio, a personal digital assistant, a mobile computer, or any other wireless communication device suitably configured to implement the processes and methods described herein.

The mobile station 105 can be configured to communicate with a point-of-sale terminal 110 in order to make payments. In one arrangement, the mobile station 105 can be configured to wirelessly communicate with the point-of-sale terminal 110 in order to make contactless payments. As used herein, the term “contactless payment” means a payment transaction in which the mobile station 105 need not physically contact the point-of-sale terminal 110 in order to communicate financial account information. For example, the mobile station 105 can communicate with the point-of-sale terminal 110 in accordance with a near field communication (NFC) protocol, IEEE 802.11, Bluetooth or ZigBee, infrared signaling, or any other suitable wireless communications protocol. In another arrangement, the mobile station 105 can be configured to communicate with the point-of-sale terminal 110 in another suitable manner, for instance via a wired connection. For example, the mobile station 105 can communicate with the point-of-sale terminal 110 via a universal serial bus (USB) port, and IEEE-1394 port, or any other suitable communications port. Still, the mobile station can communicate with the point-of-sale terminal 110 in any other suitable manner and the invention is not limited in this regard.

The point-of-sale terminal 110 can be a stationary or portable device. For instance, in a grocery store the point-of-sale terminal 110 can be located at a check-out counter. In a restaurant, the point-of-sale terminal 110 can be presented to a user at the user's table for payment processing. The point-of-sale terminal 110 also can be implemented in any other suitable manner and the invention is not limited in this regard. The point-of-sale 110 terminal can comprise one or more communications adapters suitable for communicating with the mobile station 105 and/or communicating with a server for credit authorizations. For instance the point-of-sale terminal 110 can include one or more suitable communications ports, infrared ports, wireless transceivers, communications modems, or the like.

In operation, the mobile station 105 can automatically select a financial account (e.g. a credit or debit account) to be used to make a contactless payment. To facilitate account selection, one or more user profiles can be associated with each of the financial accounts. During a payment transaction, at least one of the user profiles can be identified and account information 115 for a financial account that corresponds to the identified profile can be wirelessly communicated from the mobile station 105 to the point-of-sale terminal 110. The account information can be associated with a primary, or highest priority, financial account. If the primary financial account cannot be used to make payment in the transaction, another financial account associated with the identified user profile can be used. The account information 115 can be processed by the point-of-sale terminal 110 to receive payment for merchandise or service.

The user profile can be identified in any suitable manner. In one arrangement, the user profile can be selected by a user via a user interface on the mobile station 105 or on the point-of-sale terminal 110. For example, the user profile can be selected by the user in response to a financial transaction being initiated. The user profile also can be selected based on one or more user selectable mobile station settings.

In another arrangement, each of a plurality of user profiles can be associated with one or more suitable parameters and such parameters can be processed in order to identify the user profile. One example of a parameter that may be associated with a user profile is an accessory identifier 120 generated by a mobile station accessory 125. The mobile station accessory 125 can be, for instance, a speakerphone, a headset, headphones, or the like. The accessory identifier 120 can comprise a media access control (MAC) identifier, a user assigned identifier, an RF identification (RFID), or any other identifier which may identify a particular accessory 125 and can be communicated to the mobile station 105.

Identifiers generated by other items also can be communicated to the mobile station 105 and associated with user profiles. For example, an identifier 130 generated by a wearable item 135 can be associated with a user profile. The identifier 130 can be generated by an RFID chip 140 or any other suitable device attached to, or embedded in, the wearable item 135. Examples of the wearable item 135 can include, but are not limited to, a hat, sunglasses, a wallet, a coat, a shirt, trousers, a dress, a skirt, a shoe, a briefcase, a watch and jewelry. Still, identifiers generated by any other items can be associated with user profiles and are within the intended scope of the present invention.

Another parameter that may be associated with a user profile is a location identifier 145. The location identifier 145 can be an identifier transmitted by a beacon or transponder 150 at a specific location or generated by the point-of-sale terminal 110. In such an arrangement the location identifier 145 can be received wirelessly by the mobile station 105. In another arrangement, the location identifier 145 can be manually entered into the mobile station 105. Still, the location identifier 145 can be generated in any suitable manner and received by the mobile station 105 in any suitable manner and the invention is not limited in this regard.

Other parameters also can be processed to identify a user profile. Such parameters can include, for example, particular time periods, days of the week, months of the year, or any other time related parameters. The parameters also can include poisoning information received via a positioning system, for example a global positioning satellite (GPS) receiver. Such information can indicate a location of the mobile station 105 and/or movement of the mobile station 105.

Yet another example of parameters that can be processed to identify a user profile can be data received from a biometric sensor that senses biometric parameters of a user. The data can represent, for instance, a fingerprint, a voice print, a retina identifier, or any other biometric parameters that may be measured.

In addition to selecting the financial account based on an identified user profile, information about one or more of the financial accounts can be processed in order to select the financial account to use for making a payment at the point-of-sale terminal 110. For example, financial information 155 for one or more of the financial accounts can be communicated to the mobile station 105 prior to, or during, the payment transaction. The mobile station 105 can request the financial information 155 in response to a user input, a scheduled update, detecting the location identifier 145, detecting commencement of a payment transaction, or in response to any other suitable event.

The financial information 155 can be received from one or more network nodes 160 via a communications network 165. Suitable security protocols can be implemented to protect against unauthorized access to the financial information 155. The network nodes 160 can be web servers, network servers, local area network servers, or any other network nodes which can communicate the financial information 155 to the mobile station 105 via the communications network 165. The communications network 165 can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network 165 can include wired and/or wireless communication links.

The financial information 155 can include account balances, credit limits, available credit, interest rates, payment due dates, or any other information which may be processed to select a financial account to use to make payment. For example, if a first financial account would normally be selected based on the identified user profile, but the available credit on that account is insufficient to complete the financial transaction, a second financial account can be selected. The second financial account also can be selected based upon the identified user profile.

By way of example, assume that the item identifier 130 indicates that the user is wearing a business suit, and the user only wears his business suit while on company business. Also assume that the business has two financial accounts available for use by the user, a primary credit account and a secondary credit account. If the financial information 155 indicates that the credit available from the primary credit account is insufficient to cover the financial transaction, the secondary credit account can be automatically selected to make payment for the transaction.

Further, messages 170 can be automatically generated from the mobile station 105 to one or more contacts associated with the financial accounts. For example, an electronic message 170 can be automatically generated each time a financial transaction is completed by the mobile station 105 using one or more of the financial accounts. Accordingly, a designated contact can monitor the extent to which a particular financial account is used.

In another arrangement, in response to the financial information 155 indicating that insufficient credit, or credit below a threshold value, is available from one or more of the financial accounts, an electronic message 170 can be generated to a designated contact for such accounts. An alert also can be presented by the mobile station's user interface to notify the user of the available credit status. Further, account balances, pre-determined spending allowances, or any other desired information also may be presented to the user and/or communicated to an account contact.

In yet another arrangement, if the financial information 155 indicates that a particular financial account is restricted from use at a location identified by the location identifier 145, a message can be generated to the contact(s) associated with the financial account in response to the user attempting to access the financial account at the identified location. In addition, one or more financial accounts can be deactivated or their use by the mobile station 105 can be blocked.

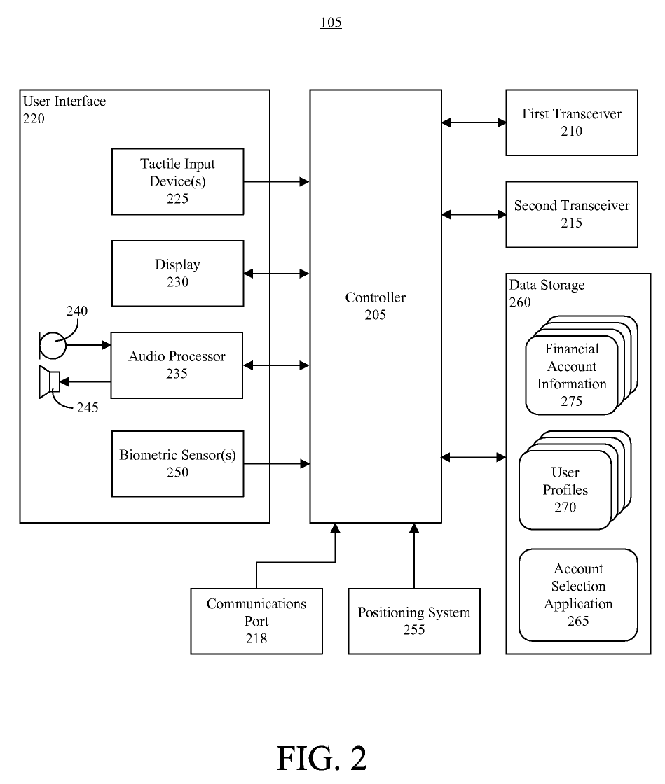

FIG. 2 depicts an example of the mobile station 105 that is useful for understanding the present invention. The mobile station 105 can include a controller 205. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The mobile station 105 also can include a first transceiver 210. The first transceiver 210 can modulate and demodulate signals to convert signals from one form to another, and can transmit and/or receive such signals over one or more various wireless communication networks. In illustration, the first transceiver 210 can be configured to communicate data via IEEE 802 wireless communications, for example, 802.11 and 802.16 (WiMax), WPA, or WPA2. In another example, the transceiver 210 can communicate data via GSM, TDMA, CDMA, WCDMA, OFDM, or direct wireless communication. Further, the transceiver 210 also can be configured to communicate over a wireless communication link using any of a myriad of communications protocols, for example, TCP/IP.

The first transceiver 210 can receive financial information from one or more network nodes and/or receive identifiers from beacons, transponders, mobile station accessories, wearable items, and the like. The first transceiver 210 can communicate received information and/or identifiers to the controller 205, or any other suitable mobile station components. The first transceiver 210 also can receive requests, electronic messages, and/or other information from the controller 205 (or other suitable mobile station components) and communicate such information via a communications network. For example, the first transceiver 210 can communicate electronic messages to identified contacts and communicate requests to one or more network nodes, as described with reference to FIG. 1 and throughout the specification.

The mobile station 105 also can include a second transceiver 215. The second transceiver 215 also can modulate and demodulate signals to convert signals from one form to another. In one arrangement, the second transceiver 215 can be configured to communicate using near field communications (NFC). In another arrangement, the second transceiver 215 can be configured to communicate using Bluetooth or ZigBee. In yet another arrangement, the second transceiver 215 can communicate via IEEE 802 wireless communications, WPA, WPA2, GSM, TDMA, CDMA, WCDMA or OFDM. Fewer or additional transceivers can be included within the mobile station 105. As such, the particular number of transceivers included within the mobile station 105 and/or the particular communication protocols used are not intended to limit the present invention.

The second transceiver 215 can exchange financial transaction information with point-of-sale terminals, as well as receive identifiers from beacons, transponders, mobile station accessories, wearable items, and the like. The second transceiver 215 can communicate to the controller 205 the identifiers, information received from point-of-sale terminals, and/or other received information. Alternatively, such information can be communicated to any other suitable mobile station components. The second transceiver 215 also can communicate information to other devices. For instance, the second transceiver 215 can communicate account information to point-of-sale terminals.

In an alternate arrangement, in lieu of, or in addition to the second transceiver 215, the mobile station 105 can include one or more communications ports 218 used by the mobile station 105 to exchange information with other devices. For example, a communications port 218 can by used by the mobile station to communicate account information to point-of-sale terminals. The communications port 218 can include, for instance, a universal serial bus (USB) port, an IEEE-1394 port, and/or any other suitable communications port(s).

The mobile station 105 also can include a user interface 220 comprising one or more tactile input devices 225 and a display 230. The tactile input devices 225 can comprise one or more buttons, keys, soft keys, sensors, or any other devices suitable for receiving a tactile user input. The display 230 can be a liquid crystal display (LCD), a liquid crystal on silicon (LCOS) display, a cathode ray tube (CRT), a plasma display, or any other suitable display. In one arrangement, the display 230 can comprise a touch screen that can receive tactile and/or stylus inputs and communicate such inputs to the controller 205.

The user interface 220 further can include an audio processor 235 connected to an input audio transducer 240 (e.g. microphone) and an output audio transducer 245 (e.g. loudspeaker). The audio processor 235 can be integrated with the controller 205 or provided as a separate component that is communicatively linked to the controller 205. The audio processor 235 can comprise a CPU, a DSP, an ASIC, a PLD, a plurality of discrete components that cooperate to process audio data, and/or any other suitable audio processing device.

The audio processor 235 can receive output audio signals from the controller 205 and communicate such signals to the output audio transducer 245. Similarly, the audio processor 235 can receive input audio signals from the input audio transducer 240 and communicate such signals to the controller 205. In one arrangement, speech recognition can be implemented to process such signals.

Further, additional devices (not shown) can be components of the user interface 220. For instance, the user interface 220 also can include a headset, a speakerphone, or other device(s) communicatively linked to the mobile station 105 via the first transceiver 210, the second transceiver 215, and/or the communications port 218.

In one arrangement, the controller 205 can process audio signals received from the audio processor 235 to identify a voice print. Identification of voice prints is known to the skilled artisan. Further, the controller 205 can receive biometric information associated with a user from one or more biometric sensors 250. The biometric sensors 250 can include, for example, a fingerprint sensor, a retina identification sensor, and/or any other sensor suitable for measuring biometric parameters.

The mobile station 105 also can include a positioning system 255. The positioning system 255 can comprise, for example, a global positioning system, such as a GPS receiver. Positioning systems are known to the skilled artisan. The positioning system 255 can communicate positioning information to the controller 205. The controller 205 can process such information to identify where the mobile station 105 is located and/or to identify movement of the mobile station 105.

The mobile station 105 further can include data storage 260. The data storage 260 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 260 can be integrated into the controller 205, though this need not be the case.

An account selection application 265, user profiles 270, and financial account information 275 can be contained on the data storage 260. The controller 205 can execute the account selection application 265 to implement the processes and methods described herein. For example, during a payment transaction the account selection application 265 can be executed to identify an appropriate user profile 270 and select a financial account 275 that is associated with the identified user profile 270. The controller 205 also can execute the account selection application 265 to communicate information for the selected account 275 to the second transceiver 215, which can transmit the information to a point-of-sale terminal in order to make a payment using the selected financial account.

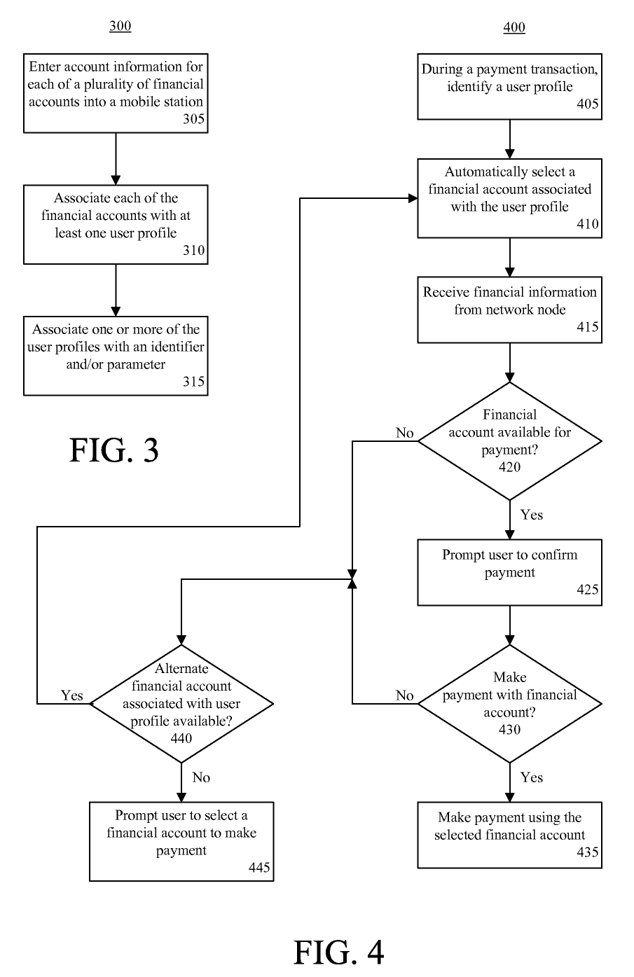

FIG. 3 is a flowchart presenting a method 300 that is useful for understanding the present invention. The method 300 can begin in a state in which a mobile station has been configured to receive financial account information. At step 305, account information for each of a plurality of financial accounts can be entered into the mobile station. At step 310, each of the financial accounts can be associated with at least one user profile. The user profile can be generated prior to, or after, the account information has been entered. In one arrangement, the same user profile can be associated with a plurality of financial accounts, and the financial accounts can be prioritized with respect to the user profile.

At step 315, one or more of the user profiles can be associated with an identifier. As noted, the identifier can be a time parameter, an item identifier, an accessory identifier, a location identifier, or any other suitable identifier. By way of example, after entering information for a particular financial account, the user can be prompted to create a user profile and associate identifiers and/or other parameters with the user profile. In one arrangement, the user can be prompted to activate one or more devices which are to be associated with the user profile. The devices can generate identifiers that are detectable by the mobile station. For instance, the mobile station can receive the identifiers via a wired connection or via RF signals transmitted by the devices (e.g. in accordance with the Bluetooth, ZigBee and/or 802.11 protocols). The mobile station can associate the received identifiers with the financial account. Of course, the user can be prompted to confirm any such associations.

The user also can be prompted to select one or more category identifiers to associate with the user profile. For example, the user can select “restaurants,” “gas stations,” “toll booths,” “grocery stores,” “department stores,” “home improvement stores,” and so on. The user also can be provided an opportunity to select an identifier for a particular location. The user can manually enter such identifier, retrieve the identifier from a list that tracks locations previously visited (e.g. locations visited which generate an identifier via a transponder or beacon that was detected by the mobile station), or retrieve the identifier from the location (e.g. from a web site hosted for the location).

The user also can be prompted to enter one or more parameters to associate with the user profile. For instance, the user can be prompted to press an appendage, such as a finger, against a fingerprint sensor, or position his eye for a retinal scan by a retina identification sensor. Still, other biometric parameters can be associated with the user profile. Moreover, the identifiers and/or parameters also can be associated with the user profile in any other suitable manner. Accordingly, the particular identifiers, parameters, and the way in which identifiers and/or parameters are associated with the user profile, are not intended to limit the present invention.

FIG. 4 is a flowchart presenting a method 400 that is useful for understanding the present invention. The method 400 can begin in a state in which information for one or more financial accounts have been entered into the mobile station and one or more of the financial accounts have been associated with respective user profiles. At step 405, a user profile can be identified during a payment transaction. For example, the user can be prompted to select a user profile, or a user profile can be automatically selected based on one or more identifiers or parameters detected by the mobile station. As noted, such identifiers can include item identifiers, accessory identifiers, location identifiers, or any other suitable identifiers detectable by the mobile station. The parameters can include biometric parameters, location parameters, parameters indicating movement, or any other parameters that may be processed to identify a user profile.

At step 410, a financial account associated with the identified user profile can be selected. Continuing to step 415, financial information associated with the selected financial account can be selected from a network node (e.g. a server which provides such information). The selected financial account can be one of a plurality of financial accounts associated with the user profile. Further, the selected financial account can be an account having the highest priority from among the associated accounts.

Referring to decision box 420, a determination can be made whether the selected financial account is available to make payment for the transaction. For instance, a determination can be made whether sufficient credit or funds are available, whether the user is authorized to make payment with the selected account at the present location, or whether there are any other circumstances that warrant denial of payment from the financial account. If the financial account is available for payment, at step 425 the user can be prompted via a user interface to confirm whether to make payment using the selected financial account. Referring to decision box 430, if the user selects to make the payment, at step 435 the payment can be made using the financial account. A message can be presented to the user via a user interface indicating payment was successful. Optionally, an electronic message can be communicated to a designated contact associated with the financial account.

Referring again to decision boxes 420 and 430, if the selected financial account is not available to make payment in the transaction, for example the financial account is not available for use at the present location or does not have sufficient available credit, or the user has selected not to make payment using the selected account, the process can proceed to decision box 440. At decision box 440, a determination can be made whether there is an alternate financial account associated with the user profile. If so, the process can return to step 410 and a next financial account can be selected. The next financial account can be one step lower in priority with respect to the immediately preceding selected financial account.

At step 415, financial information for the alternate financial account can be received from the network node. The process then can proceed as previously described. If no financial accounts associated with the user profile are available, at step 445 a message can be generated to the user alerting the user that the payment transaction cannot be processed. Optionally, an electronic message can be communicated to a designated contact.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of selecting a financial account to be used to make a payment at a point-of-sale terminal, comprising:
during a payment transaction at the point-of-sale terminal, identifying at least one of a plurality of user profiles;
selecting from a plurality of available financial accounts at least one financial account that is associated with the identified user profile; and
making the payment using the selected financial account.

2. The method of claim 1, further comprising associating each of the plurality of financial accounts with at least one user profile selected from the plurality of user profiles.

3. The method of claim 1, further comprising:
receiving a first identifier associated with a mobile station accessory;
wherein identifying the at least one user profile comprises determining that the user profile is associated with the first identifier.

4. The method of claim 3, further comprising:
receiving a second identifier associated with a location;
wherein identifying the at least one user profile comprises determining that the user profile is associated with the first identifier and the second identifier.

5. The method of claim 1, further comprising:
receiving a first identifier associated with a wearable item;
wherein identifying the at least one user profile comprises determining that the user profile is associated with the first identifier.

6. The method of claim 1, further comprising:
receiving financial information for each of the financial accounts;
wherein selecting the financial account comprises processing the financial information.

7. The method of claim 1, further comprising:
receiving at least one biometric parameter;
wherein identifying the at least one user profile comprises determining that the user profile is associated with the received biometric parameter.

8. The method of claim 1, wherein selecting at least one financial account comprises:
selecting a first financial account associated with the identified user profile; and
in response to determining that the first financial account is not available to make payment for the payment transaction, selecting a second account associated with the identified user profile.

9. The method of claim 8, wherein selecting the first financial account comprises selecting the financial account that has a highest priority from among the financial accounts associated with the user profile.

10. The method of claim 1, wherein identifying the at least one user profile comprises receiving a user selection of the user profile.

11. The method of claim 1, further comprising:
in response to making the payment, sending an electronic message to a contact associated with the selected financial account.

12. The method of claim 1, wherein making the payment comprises making a contactless payment.

13. A mobile station suitably configured to make a payment at a point-of-sale terminal, comprising:
at least a first transceiver; and
a controller that, during a payment transaction at the point-of-sale terminal, identifies at least one of a plurality of user profiles, selects from a plurality of available financial accounts at least one financial account that is associated with the identified user profile, and communicates to the transceiver information to be communicated to the point-of-sale terminal in order to make the payment for the transaction using the selected financial account.

14. The mobile station of claim 13, wherein the controller associates each of the plurality of financial accounts with at least one user profile selected from the plurality of user profiles.

15. The mobile station of claim 13, wherein:
the first transceiver or a second transceiver of the mobile station receives a first identifier associated with a mobile station accessory; and
the controller determines that the user profile is associated with the first identifier.

16. The mobile station of claim 15, wherein:
the first transceiver or the second transceiver receives a second identifier associated with a location; and
the controller determines that the user profile is associated with the first identifier and the second identifier.

17. The mobile station of claim 13, wherein:
the first transceiver or a second transceiver of the mobile station receives a first identifier associated with a wearable item; and
the controller determines that the user profile is associated with the first identifier.

18. The mobile station of claim 13, wherein:
the first transceiver or a second transceiver of the mobile station receives financial information for each of the financial accounts; and
the controller processes the financial information in order to select the financial account that is associated with the identified user profile.

19. The mobile station of claim 13, further comprising:
a biometric sensor that receives at least one biometric parameter;
wherein the controller determines that the user profile is associated with the received biometric parameter.

20. A program storage device readable by a machine, tangibly embodying a program of instructions executable by the machine to perform method steps of selecting a financial account to be used to make a payment at a point-of-sale terminal, said method steps comprising:
during a payment transaction at the point-of-sale terminal, identifying at least one of a plurality of user profiles;
selecting from a plurality of available financial accounts at least one financial account that is associated with the identified user profile; and
making the payment using the selected financial account.
